(19) United States
(12) Patent Application Publication
(10) Pub. No.: US 2003/0183891 A1
(43) Pub. Date: Oct. 2, 2003

(54) Column readout circuit with increased signal range for CMOS image sensor

(76) Inventors: Xinping He, San Jose, CA (US); Hongli Yang, Cupertino, CA (US); Qingwei Shan, San Jose, CA (US)

Correspondence Address: PERKINS COIE LLP, PATENT-SEA, P.O. BOX 1247, SEATTLE, WA, 98111-1247, US

(21) Appl. No.: 10/109,142

(22) Filed: Mar. 27, 2002

(51) Int. Cl. H01L 27/14

(52) U.S. Cl. 257/431

(57) ABSTRACT

A column readout circuit for a CMOS image sensor is disclosed. The circuit uses MOS capacitors to store a photo signal and a reset signal. Correlated double sampling is used to eliminate fixed pattern noise and 1/f noise. Additionally, the signals are coupled through the capacitors using AC coupling. In this manner, a readout circuit compatible with conventional CMOS logic processes can be manufactured.

### TECHNICAL FIELD OF THE INVENTION

The present invention relates to CMOS image sensors, and more particularly, to a readout circuit using AC coupling through a MOS capacitor.

### BACKGROUND OF THE INVENTION

Image sensors are used to produce an image representing an object. The image sensors include rows and columns of pixels. The pixels generate small photo signals proportional to light reflected from an object to be imaged. The photo signal is read and processed by signal processing circuitry to create an image representing the object.

Pixels belonging to the same column (also referred to as bitline) are usually connected at a common output node from where the signal is read out. Each pixel in a same bitline is individually controlled to read out at the common output node. At the output node, a column readout circuit is provided to read out and amplify the photo signal.

Typically, a pixel includes a driving device that receives an electronic signal indicative of an intensity of light detected by the image sensor and drives a current proportional to the intensity (the photo signal), to a bitline to which the pixel cell is coupled. Following signal integration, pixels of a selected row are accessed by asserting a row select signal to each pixel of the selected row.

Additionally, the column readout circuit, in some image sensors, is used to remove thermal noise, fixed pattern noise, and other types of noise. This is done by having the column readout circuit sample the output of the pixel during a reset period. The column readout circuit then subtracts the reset signal from the photo signal. This type of readout circuit is sometimes referred to as a correlated double sampling circuit. In some prior art image sensors, a second stage column readout circuit is used to further amplify the photo signal and to eliminate noise caused by the first stage column readout circuit.

In the column readout circuits, capacitors are required to sample and hold the photo signal and the reset signal. Typically, these capacitors are formed using two polysilicon layers (poly-poly capacitor) or two metal layers (metal-metal capacitor). However, the use of multiple polysilicon or two metal layers is not compatible with standard CMOS logic processes, thereby increasing the cost. Further, polysilicon or metal capacitors may occupy relatively large areas.

An example of a correlated double sampling column readout circuit is seen in U.S. Pat. No. 6,222,175. The circuit described therein includes capacitors C7 and C8 for holding a reset signal and a photo signal. The capacitors C7 and C8 are conventional capacitors either of the poly-poly type or of the metal-metal type. Both of these types of capacitors require additional manufacturing complexity relative to standard CMOS logic processes.

Furthermore, even if MOS capacitors are used for the capacitors C7 and C8 of the '175 patent, additional problems arise. For example, because MOS capacitors are PMOS type, there is an issue with power supply noise that may couple and directly interfere with the signal. If a NMOS type capacitor is used, the photo signal voltage and the reset signal voltage must be higher than the threshold voltage (V_{T}(N)) of the MOS capacitor such that the MOS capacitor operates in the triode region. As known, an n-type MOS capacitor has a threshold voltage wherein above that voltage, the capacitance of the MOS capacitor is substantially constant. See U.S. Pat. No. 5,962,887. Therefore, the signals on the bitline must have a magnitude that is above V_{T}(N). Oftentimes, this requirement cannot be easily met. An example of a readout circuit using MOS capacitors is seen in “Performance Analysis of a Color CMOS Photogate Image Sensor” by Blanksby et al., IEEE Transactions on Electron Devices, Vol. 47, No. 1, January 2000.

Therefore, what is needed is a column readout circuit that is compatible with standard CMOS logic processes.

### BRIEF DESCRIPTION OF THE DRAWINGS

The foregoing aspects and many of the attendant advantages of the invention will become more readily appreciated as the same become better understood by reference to the following detailed description, when taken in conjunction with the accompanying drawings, wherein:

FIG. 1 is a schematic diagram of a readout circuit formed in accordance with the present invention.

FIGS. 2A-2H are timing diagrams illustrating the operation of the various switches of the readout circuit of FIG. 1.

FIGS. 3A-3E shows the voltage levels of various nodes of the readout circuit of FIG. 1 during operation of the readout circuit.

### DETAILED DESCRIPTION OF THE PREFERRED EMBODIMENT

In the following description, numerous specific details are provided, such as the identification of various system components, to provide a thorough understanding of embodiments of the invention. One skilled in the art will recognize, however, that the invention can be practiced without one or more of the specific details, or with other methods, components, materials, etc. In still other instances, well-known structures, materials, or operations are not shown or described in detail to avoid obscuring aspects of various embodiments of the invention.

Reference throughout this specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more embodiments.

As noted above, a CMOS image sensor includes an array of pixels formed into columns and rows. Typically, each column of pixels has associated therewith a readout circuit, which is the subject of the present invention. In the description below, a single pixel is described in connection with a readout circuit. It can be appreciated that multiple readout circuits would be required for the full image sensor.

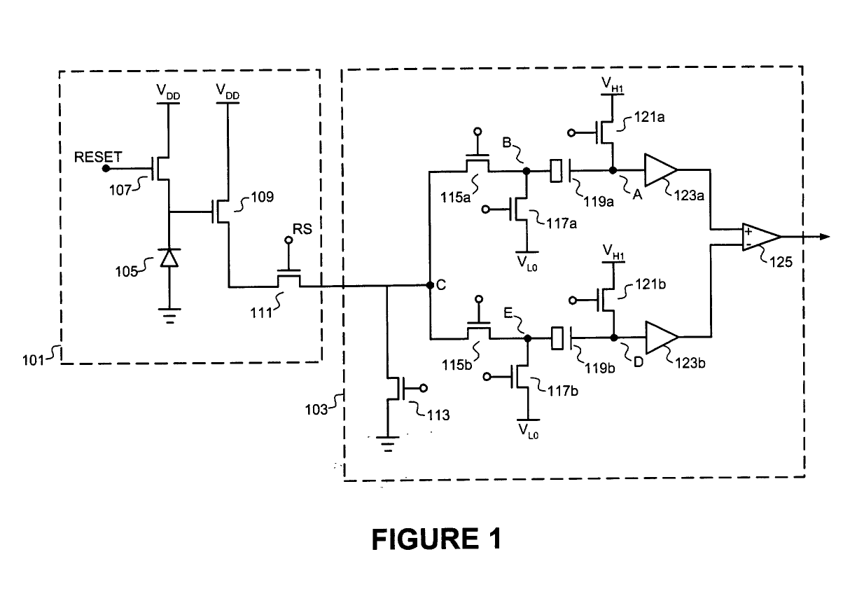

Turning to FIG. 1, an active pixel 101 is shown connected to a readout circuit 103. The active pixel 101 includes a photodiode 105, a reset transistor 107, pixel output transistor 109, and row select transistor 111. The configuration of the active pixel 101 is conventional in the prior art. In operation, the photodiode 105 provides a light signal output that is indicative of the amount of light impinging on the photodiode 105. The light signal is used to modulate the pixel output transistor 109 in order to output a photo signal if the row select (RS) transistor 111 is turned on. The pixel output transistor 109 is also referred to as being in source follower configuration. The reset transistor 107 is used to reset the pixel 101 for the next signal integration period. Moreover, while the pixel 101 in one embodiment uses a photodiode 105, the pixel 101 may use a photogate or a pinned photodiode.

The readout circuit 103 includes two branches: a first branch for capturing a reset signal and a second branch for capturing the photo signal. Specifically, the source of the pixel output transistor is connected, through row select transistor 111, to both the first and second branches. The use of the two branches allows for correlated double sampling, a technique useful for minimizing 1/f noise and fixed pattern noise. Note that for correlated double sampling, typically a shorting transistor is used between the two branches. However, for clarity purposes, the shorting transistor is omitted from the readout circuit shown in FIG. 1.

The first and second branches are essentially structured the same. For ease of understanding, like elements are designated with like numerals, except that the first branch for capturing the reset signal is designated with an “a” and the second branch for capturing the photo signal is designated with a “b”.

The readout circuit 103 includes a load transistor 113 of the pixel output transistor 109. The first and second branches each include branch select transistors 115a and 115b. These act as switches to select the branch to which the signal output by the active pixel 101 is directed. Downstream of the branch select transistors 115a and 115b are low voltage reference transistors 117a and 117b. The term downstream refers to locations in the signal path subsequent to a reference location. The drain of the low voltage reference transistors 117a and 117b are connected to the source/drain plate of MOS capacitors 119a and 119b. The source of the low voltage reference transistors 117a and 117b are connected to a voltage Vₗₒ, which may be V_{SS} or ground. Thus, the low voltage reference transistors 117a and 117b are used to periodically and selectively pull the source/drain plate to a low reference voltage.

The MOS capacitors 119a and 119b are conventional in the art, such as that described in U.S. Pat. No. 5,962,887 and the references cited therein. As detailed therein, the source/drain plate of such a MOS capacitor is formed by the channel, source and drain regions of a MOSFET.

The poly gate portion of the MOS capacitors 119a and 119b is connected to the source of high voltage reference transistors 121a and 121b . The drain of the high voltage reference transistors 121a and 121b are connected to a voltage Vₕᵢ, which may be V_{DD}. Thus, the high voltage reference transistors 121a and 121b are used to periodically and selectively pull the poly gate of the MOS capacitors 119a and 119b to a high reference voltage.

The poly gate of the MOS capacitors 119a and 119b are also connected to the input of buffers 123a and 123b. The output of the buffers is then provided to the differential amplifier 125, which amplifies the difference in the reset signal and the photo signal.

The operation of the circuit is next described. It should be noted that the readout circuit operates on two input signals: the photo signal and the reset signal. Thus, the following reading technique is repeated for both the photo signal and the reset signal. The process is identical for each, so only the process for reading the photo signal is described.

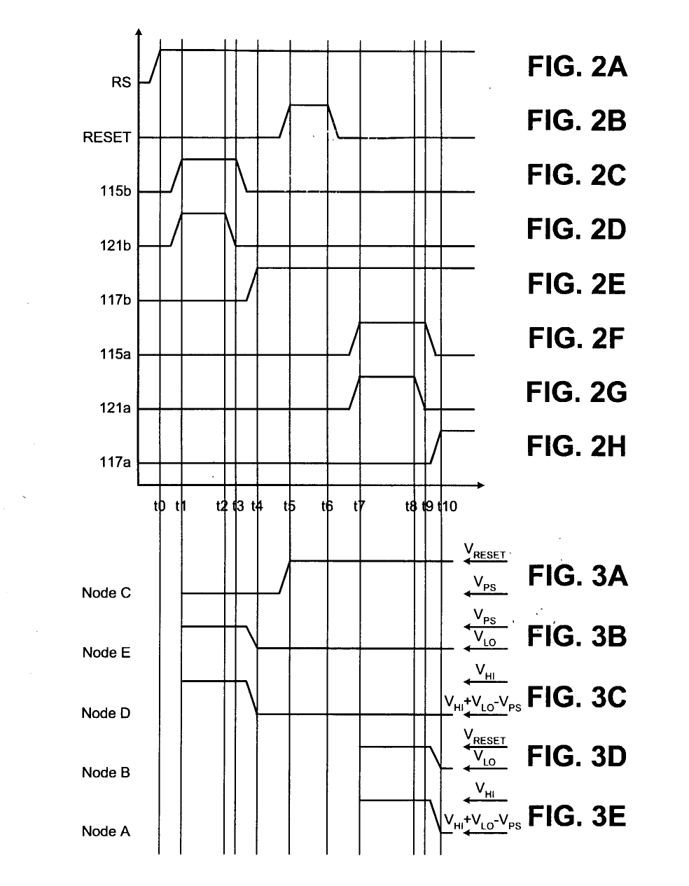

First, as seen in FIG. 2A, at a time t0, the row select transistor 111 is turned on to allow the signal output by the pixel 101 to be transferred to a node C. Next, at a time t1 as seen in FIG. 2B, the branch select transistor 115b and the high voltage reference transistor 121b is switched on. The low voltage reference transistor 117b is switched off As seen in FIG. 3C, the voltage at node D becomes Vₕᵢ, while the voltage at nodes E and C (as seen in FIGS. 3B and 3A) will be at the photo signal level (Vₚₛ).

Next, at times t2 and t3, as seen in FIGS. 2D and 2C, the high voltage reference transistor 121b and the branch select transistor 115b are turned off sequentially. This causes the photo signal Vₚₛ to be stored at node E. Note that node D remains at the high voltage reference Vₕᵢ. These first two steps cause the photo signal to be captured on the source/drain plate of the MOS capacitor 119b, while the poly plate has a voltage Vₕᵢ.

Next, at time t4, the high voltage reference transistor 121b and the branch select transistor 115b remain off. However, at time t4, as seen in FIG. 2E, the low voltage reference transistor 117b is turned on. This causes the photo signal voltage Vₚₛ at node E to be “transferred” to node D of the MOS capacitor 119b through AC capacitive coupling. In particular, the signal transferred is not precisely Vₚₛ, but rather a voltage shifted version that is Vₕᵢ+Vₗₒ−Vₚₛ. If the magnitudes of Vₕᵢ and Vₗₒ are correctly selected, this technique results in the capacitors 119a and 119b to always operate in the triode region. Specifically, if Vₗₒ is ground, then the difference between Vₕᵢ and Vₚₛ (maximum value) should be above the threshold voltage of the MOS capacitor 119 in order to maintain operation in the triode region.

In turn, the voltage shifted version of the photo signal voltage Vₚₛ at node D is provided through buffer 123b to differential amplifier 125. Finally, as seen in FIG. 2B, the reset transistor 107 is turned on for some time period (t5 through t6) that will allow the pixel to reset.

A similar process is performed on the reset signal branch in order to process the reset signal. Thus, at time t7, the high voltage reference transistor 121a and the select transistor 115a are turned on. This allows the reset signal to be placed onto nodes C and B, while node A becomes Vₕᵢ. At times t8 and t9, as seen in FIGS. 2F and 2G, the high voltage reference transistor 121a and the branch select transistor 115a are turned off sequentially. This causes the reset signal to be stored at node B. Note that node A remains at the high voltage reference Vₕᵢ. These steps cause the reset signal to be captured on the source/drain plate of the MOS capacitor 119a, while the poly plate has a voltage Vₕᵢ.

Next, at time t10, the high voltage reference transistor 121a and the branch select transistor 115a remain off. However, at time t10, as seen in FIG. 2H, the low voltage reference transistor 117a is turned on. This causes the reset signal at node B to be “transferred” to node A of the MOS capacitor 119a through AC capacitive coupling. In particular, the signal transferred is not precisely the reset signal, but rather a voltage shifted version that is Vₕᵢ+Vₗₒ−Vᵣₑₛₑₜ. In turn, the voltage shifted version of the reset signal at node A is provided through buffer 123a to differential amplifier 125.

As noted above, while the voltage values Vₕᵢ and Vₗₒ are generally arbitrary, in some embodiments, Vₕᵢ is simply V_{DD} and Vₗₒ is simply V_{SS} or ground. Still alternatively, the capacitors 119a and 119b may be PMOS based. In such a situation, the gate of the PMOS capacitor should be connected to the bitline.

The buffers 123a and 123b may be, for example, a transistor in source follower configuration. If Vₕᵢ is set at V_{DD}, the signal range of the source follower is increased. Alternatively, if the buffers 123a and 123b are operational amplifiers, the voltage levels of Vₕᵢ and Vₗₒ may be adjusted to meet the operational amplifiers' input common mode range, to allow for flexible adjustability.

After the reset signal and the photo signal are buffered by the buffers 123a and 123b, the signals are provided to differential amplifier 125, where the reset signal is subtracted from the photo signal, and the result is amplified to provide the output of the column readout circuit 103.

While the preferred embodiment of the invention has been illustrated and described, it will be appreciated that various changed can be made therein without departing from the spirit and scope of the invention. For example, while the present invention has been described in terms of using a photodiode, other types of photosensitive or light sensing elements may also be used, such as a photogate, pinned photodiode, and the like. Further, the above examples are described using a p-type substrate and photodiode. For an n-type substrate or a photogate sensor, the present invention is equally applicable to one of ordinary skill.

Thus, one of ordinary skill after reading the foregoing specification will be able to affect various changes, alterations, and substitutions of equivalents without departing from the broad concepts disclosed. It is therefore intended that the scope of the letters patent granted hereon be limited only by the definitions contained in appended claims and equivalents thereof, and not by limitations of the embodiments described herein.

We claim:

1. A column readout circuit for reading out a photo signal and a reset signal provided by a pixel, the circuit comprising:
a reset signal branch including a first MOS capacitor having a first terminal and a second terminal, said second terminal selectively connected to a high voltage reference, said first capacitor selectively connected to said pixel and a low voltage reference; and
a photo signal branch including a second MOS capacitor having a first terminal and a second terminal, said second terminal selectively connected to said high voltage reference, said first capacitor selectively connected to said pixel and said low voltage reference.

2. The readout circuit of claim 1 further wherein said first and second MOS capacitors are operating in the triode region.

3. The readout circuit of claim 1 wherein said pixel includes a photosensitive element selected from the group of photodiode, photogate, or pinned photodiode.

4. The readout circuit of claim 1 further including a differential amplifier for receiving as inputs a first signal from said second terminal of said first MOS capacitor and a second signal from said second terminal of said second MOS capacitor.

5. The readout circuit of claim 4 further including buffers disposed between said first and second MOS capacitors and said differential amplifier.

6. The readout circuit of claim 1 wherein the difference between the high voltage reference and a maximum value of the photo signal or the reset signal is greater than a threshold voltage of said first or second MOS capacitor.

7. A method of reading out a photo signal from a pixel comprising:
coupling said photo signal onto a first terminal of a MOS capacitor;
placing a high voltage reference onto a second terminal of said MOS capacitor;
coupling said first terminal of said MOS capacitor to a low voltage reference such that said photo signal is transferred through said MOS capacitor by capacitive coupling to said second terminal of said MOS capacitor; and
reading said photo signal from said second terminal of said MOS capacitor.

8. The method of claim 7 further wherein said MOS capacitor is operating in the triode region.

9. The method of claim 7 wherein said photo signal on said second terminal of said MOS capacitor is provided to one input of a differential amplifier.

10. The method of claim 9 wherein said photo signal on said second terminal of said MOS capacitor is provided to said differential amplifier through a buffer.

11. The method of claim 7 wherein the difference between the high voltage reference and a maximum value of the photo signal is greater than a threshold voltage of said MOS capacitor.

12. The method of claim 7 further including:
coupling a reset signal onto a first terminal of a second MOS capacitor;
placing said high voltage reference onto a second terminal of said second MOS capacitor;
coupling said first terminal of said second MOS capacitor to said low voltage reference such that said reset signal is transferred through said second MOS capacitor by capacitive coupling to said second terminal of said second MOS capacitor; and
reading said reset signal from said second terminal of said second MOS capacitor.

13. The method of claim 12 further wherein said second MOS capacitor is operating in the triode region.

14. The method of claim 12 wherein said reset signal on said second terminal of said second MOS capacitor is provided to an input of a differential amplifier.

15. The method of claim 14 wherein said reset signal on said second terminal of said second MOS capacitor is provided to said differential amplifier through a buffer.

16. The method of claim 12 wherein the difference between the high voltage reference and a maximum value of the reset signal is greater than a threshold voltage of said second MOS capacitor.
